(19) United States
(12) Patent Application Publication
(10) Pub. No.: US 2026/0075215 A1
(43) Pub. Date: Mar. 12, 2026

(54) ADAPTIVE PREDICTION COST ESTIMATION FOR VIDEO ENCODING

(71) Applicant: Intel Corporation, Santa Clara, CA (US)

(72) Inventors: Ximin Zhang, San Jose, CA (US); Yi-Jen Chiu, San Jose, CA (US); Keith W. Rowe, Shingle Springs, CA (US)

(73) Assignee: Intel Corporation, Santa Clara, CA (US)

(21) Appl. No.: 19/386,937

(22) Filed: Nov. 12, 2025

(51) Int. Cl. H04N 19/156; H04N 19/14; H04N 19/169

(52) U.S. Cl. CPC H04N 19/156; H04N 19/14; H04N 19/1883

(57) ABSTRACT

Systems and methods for adaptive prediction cost estimation in video encoding are provided. The techniques improve early cost estimation and reduce the number of candidates for the later decision stages and final RDO stage. In particular, an adaptive sum of absolute transformed differences (SATD) is determined for each candidate, and, based on the adaptive SATD values, a subset of candidates is selected for mode decision search to determine block partitioning, motion vectors, and encoding modes, The adaptive SATD combines a weighted DC component of the SATD and the AC component of the SATD. The weighting factor is selected from a DC adjustment ratio table based on the spatial variation and the QP for a respective coding tree unit. The techniques improve cost estimation accuracy, reduce encoding complexity, and are hardware-friendly for integration into video codecs such as HEVC, AV1, VVC, and AV2.

### BACKGROUND

Video compression is a technique for making video files smaller and easier to transmit over the Internet. There are different methods and algorithms for video compression, with different performance and tradeoffs. Video compression involves encoding and decoding. Encoding is the process of transforming (uncompressed) video data into a compressed format. Decoding is the process of restoring video data from the compressed format. An encoder-decoder system is called a codec.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a system for adaptive prediction cost estimation for video coding, according to some embodiments of the disclosure.

FIG. 2 illustrates an example method for generating a DC adjustment ratio table, according to some embodiments of the disclosure.

FIG. 3 illustrates an example 300 of a DC adjustment ratio table, according to some embodiments of the disclosure.

FIG. 4 illustrates partitioning, according to some embodiments of the disclosure.

FIG. 5 illustrates intra-prediction modes, according to some embodiments of the disclosure.

FIG. 6 illustrates an example system for encoding and decoding video frames 604, according to some embodiments of the disclosure.

FIG. 7 illustrates a method of adaptive prediction cost estimation, according to some embodiments of the disclosure.

FIG. 8 depicts a block diagram of an exemplary computing device, according to some embodiments of the disclosure.

### DETAILED DESCRIPTION

### Overview

Video coding or video compression is the process of compressing video data for storage, transmission, and playback. Video compression may involve taking a large amount of raw video data and applying one or more compression techniques to reduce the amount of data needed to represent the video while maintaining an acceptable level of visual quality. In some cases, video compression can offer efficient storage and transmission of video content over limited bandwidth networks.

A video includes one or more (temporal) sequences of video frames or frames. A frame may include an image, or a single still image. A frame may have millions of pixels. For example, a frame for an uncompressed 4K video may have a resolution of 3840×2160 pixels. Pixels may have luma/luminance and chroma/chrominance values. The terms “frame” and “picture” may be used interchangeably.

In some cases, a frame may be partitioned into one or more blocks. Blocks may be used for block-based compression. The blocks of pixels resulting from partitioning may be referred to as partitions. Blocks may have sizes which are much smaller, such as 512×512 pixels, 256×256 pixels, 128×128 pixels, 64×64 pixels, 32×32 pixels, 16×16 pixels, 8×8 pixels, 4×4 pixels, etc. A block may include a square or rectangular region of a frame. Various video compression techniques may use different terminology for the blocks or different partitioning structures for creating the blocks. In some video compression techniques, a frame may be partitioned into Coding Tree Units (CTUs). A CTU may be divided (separately for luma and chroma components) into Coding Tree Blocks (CTBs). A CTB can have a size of 64×64 pixels, 32×32 pixels, or 16×16 pixels. A CTB can be divided into Coding Units (CUs). A CU can be divided into Predicition Units (PUs) and/or discrete cosine transforms (DCT) Transform Units (TUs). CTUs, CTBs, CUs, PUs, and TUs may be considered blocks or partitions herein.

One of the tasks of an encoder in a video codec is to make encoding decisions at different levels for the video (e.g., sequence level, GOP level, frame/picture level, slice level, CTU level, CTB level, block level, CU level, PU level, TU level, etc.), based on a desired bitrate and/or desired (objective and/or subjective) quality. Making encoding decisions may include evaluating different options or parameter values for encoding the data, and determining optimal options or parameter values that may achieve the desired bitrate and/or quality. The chosen option and/or parameter values may be applied to encode the video to generate a bitstream. The chosen option and/or parameter values would be encoded in the bitstream to signal to a decoder how to decode the encoded bitstream in accordance with the encoding decisions which were made by the encoder. Modern codecs offer a wide range of options and parameter values. While evaluating all possible combinations of options and parameter values may yield the most optimal encoding decision, an encoder does not have unlimited resources to afford the complexity that would be required to evaluate each available option and parameter value.

While some codecs can achieve significant subjective quality improvement with similar bitrates compared to earlier codecs, the improvements came at a cost of added complexity in the encoder and decoder. Some of the complexity increase is due to added available block partitioning structures and available coding tools for coding the blocks or partitions. The added available block partitioning structures mean that a frame, or a portion of a frame (e.g., a CTU), can be partitioned using a variety of available partitioning structures into blocks or partitions (e.g., CUs). There may be many (e.g., dozens to hundreds) diverse ways to partition frame or the portion of the frame into blocks or partitions. The added available coding tools for coding the blocks/partitions mean that the coding tools are evaluated for each block/partition after partitioning and for every way the frame or the portion of the frame is partitioned.

To find an optimal block partitioning and a set of coding tools for the blocks/partitions, e.g., such as finding optimal partitioning of a CTU and coding tools for the CUs or partitions of the CTU, an encoder may evaluate the bitrate and distortion for all feasible combinations of block partitioning structures and coding tools for the blocks/partitions and find the combination that yields the best rate-distortion cost. It has been determined from experiments that the complexity increase can cause the runtime associated with performing extensive rate-distortion cost computations for intra-prediction coding to increase by 20 times when compared to earlier codecs. It is a technical challenge to find an encoding solution that can reduce complexity for intra-prediction encoding while maintaining the quality gains from the added available block partitioning structures and available coding tools for coding the blocks/partitions.

In general, video encoding standards have achieved coding gain by adding encoding modes, features, block partitions and finer motion vector resolutions. In particular, various video encoding standards include Advanced Video Coding (AVC), High Efficiency Video Coding (HEVC), and Versatile Video Coding (VVC). AVC is a video compression standard that uses macroblocks (e.g., 16×16 pixels), and supports inter-frame prediction (temporal compression) and intra-frame prediction (spatial compression) to deliver efficient compression. HEVC provides better compression efficiency than AVC, with a 50% bitrate reduction compared to AVC, and uses CTUs instead of macroblocks, allowing for more flexible block sizes. HEVC also provides advanced intra-prediction and inter-prediction and supports much high resolution videos. VVC is a block-based hybrid video codec designed to improve compression efficiency over previous standards, providing up to 50% more efficiency than HEVC and around 75% more efficiency over AVC.

In some examples, VVC uses CTUs and can have CU size ranges from 128×128 to 4×4. VVC can include multi-type tree splitting mode (i.e., quadtree, binary tree, and ternary tree) to support non-square partition. VVC offers significant technical advantages over its predecessors HEVC and AVC. However, the complexity of the VVC is also significantly increased as compared to other encoding standards. In some examples, the encoding and decoding complexity increase is due in part to the newly added block partitions and coding tools. To find the optimal partitioning and coding tool for a coding tree unit (CTU), the encoder computes the bit rate and distortion optimization (RDO) of all feasible candidates (combinations of the block partitions and corresponding coding tools with various motion vectors). However, these computations can result in significantly increased complexity for VVC. Similarly, other advanced video encoding standards such as AOMedia Video 1 (AV1) and AOMedia 2 (AV2) also include computations that can also result in significantly increased complexity.

To reduce complexity of advanced video encoding standards, multiple stage decisions can be used. In the earlier stages, simple cost estimation is used to select a subset of the candidates. For example, rate distortion optimization (RDO) can be applied only to a limited number of selected candidates in the final stage to find the best candidate. RDO balances rate (the number of bits used to encode the video) with distortion (the loss of quality that occurs due to compression). For simple cost estimation, the Sum of Absolute Transformed Differences (SATD) can provide relatively accurate cost representation with reasonable complexity. Thus, SATD is often used in modern video encoding solutions. However, to fully achieve the encoding benefits for the latest coding standards, SATD based approaches need to keep a large number of candidates for the later encoding stages and for the final RDO stage.

According to various implementations, systems and methods are provided herein to improve early cost estimation and reduce the number of candidates for the later decision stages and final RDO stage. In some examples, the candidates can include block partitioning candidates, intra-prediction candidates, and/or inter-prediction candidates. The techniques include generating a DC adjustment ratio table. During the encoding process, spatial variation features are calculated for each CTU. The extracted features and encoding quantization parameter (QP) are used to select the DC adjustment ratio from the look-up table. The DC adjustment ratio is used to adjust the DC value of SATD. The modified SATD value is used to select a subset of candidates. The systems and methods provided herein can be used with a VVC encoder to achieve significant complexity reduction with negligible quality impacts. Additionally, the systems and methods provided herein can be used with a VVC encoder to achieve better quality encoding with the same complexity as other methods. The methods can be integrated into HEVC, AV1, VVC and AV2 video.

Techniques for making intra-prediction decisions described and illustrated herein may be applied to a variety of codecs, such as AVC (Advanced Video Coding), HEVC (High Efficiency Video Coding), AV1 (AOMedia Video 1), and VVC (Versatile Video Coding). AVC, also known as “ITU-T H.264”, was approved in 2003 and last revised 2021 Aug. 22. HEVC, also known as “ITU-T H.265”, was approved in 2013 and last revised 2023 Sep. 13. AV1 is a video coding codec designed for video transmissions over the Internet. “AV1 Bitstream & Decoding Process Specification” version 1.1.1 with Errata was last modified in 2019. VVC, also known as “ITU-T H.266”, was finalized in 2020. While the techniques described herein relate to VVC, it is envisioned by the disclosure that the techniques may be applied to other codecs having block partitioning and intra-prediction decisions that are the same or similar to the ones made in VVC.

### Example System of Adaptive Prediction Cost Estimation for Video Coding

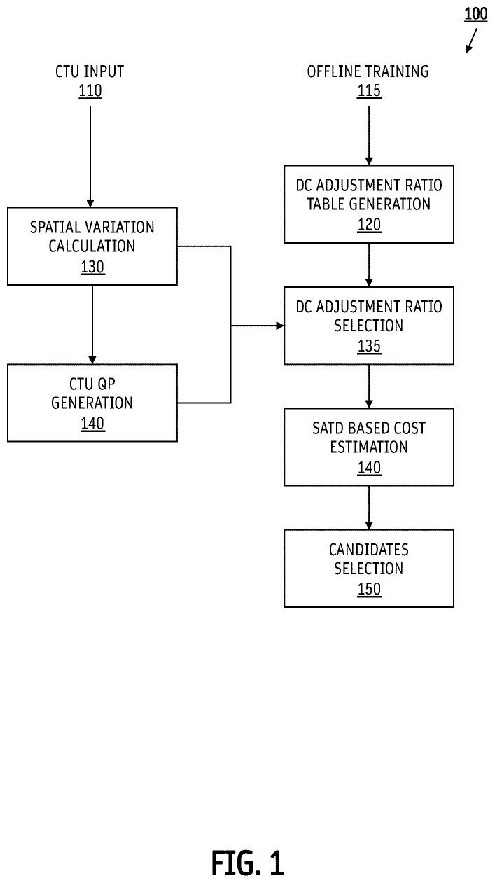

FIG. 1 illustrates a system 100 for adaptive prediction cost estimation for video coding, according to some embodiments of the disclosure. The system 100 improves encoding quality and reduces encoding complexity. In particular, recent codecs, for examples codecs for VVC, AV1 and AV2 are becoming increasingly complex. Using the system 100, the cost estimation accuracy is improved with negligible hardware and software computation. In some implementations, using the system 100 with a VVC reference encoder results in significant complexity reduction with negligible quality impacts. In some implementations, using the system 100 with a VVC reference encoder results in better quality output with same complexity encoding. According to various examples, the system 100 is hardware friendly and can be integrated into HEVC, AV1, VVC, and AV2 video solutions. Hardware friendly can mean, for example, having low computational complexity.

The system 100 uses as input a DC adjustment ratio table, which is generated for the codec. Additionally, spatial variation is determined for each CTU. In general, the spatial variation can represent sharpness of the image, or variance among pixels. Thus, for a monotonic background (e.g., a white background or a grey background), the spatial variation is very small and may be zero or have a value that is close to zero. In contrast, for an image including text, the spatial variation is high, since the text has high contrast and sharp edges compared to the background. The extracted features and encoding QP are used to select the DC adjustment ratio from a look-up table. The DC adjustment ratio is then used to adjust the DC value of the SATD. The modified SATD value is used to select a subset of candidates for the subsequent decisions. Thus, the system 100 adaptively adjusts the SATD value.

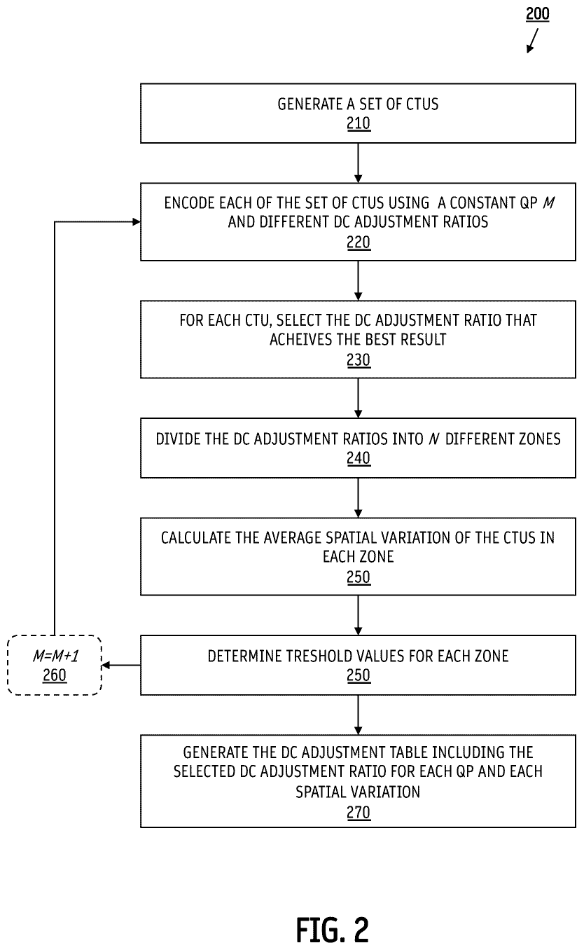

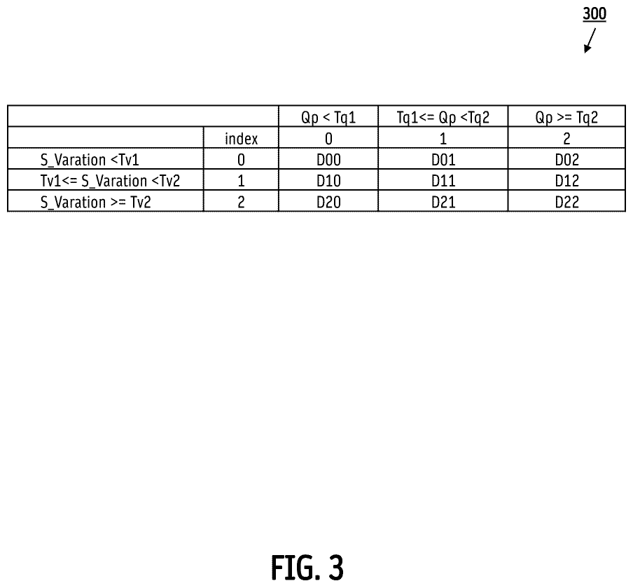

According to various implementations, as shown in FIG. 1, the CTU level adaptive prediction cost estimation system includes a number of elements. In particular, at module 115, offline training can be used to generate a DC adjustment ratio table 120, as described in greater detail with respect to FIGS. 2 and 3. In some examples, offline training can be performed one time to generate a universal table that can be used for any video codec. In some examples, different tables can be generated for different use cases, for instance for different codecs and/or for different applications. An example table is shown in FIG. 3, discussed below.

According to various implementations, during video encoding, a CTU input 110 is received, and, at 130, spatial variation calculated for each CTU. At module 140, the system 100 generates a Quantization Parameter (QP) at the Coding Tree Unit (CTU) level using encoding bitrate control. This means that for each CTU (i.e., for a block or region of pixels within a video frame) the encoder determines a QP value based on a selected bitrate for the video stream. In various examples, the QP value determines the degree of compression applied to the data in each CTU, and thus affects both the image quality and the size of the resulting encoded bitstream. In some examples, bitrate control mechanisms analyze the content of each CTU and the overall encoding settings to set QP values that help meet target bitrate constraints. For example, if a section of the video is more complex or detailed, the encoder might use a lower QP (less compression, higher quality) to preserve visual fidelity. Conversely, for simpler or less important sections, a higher QP (more compression, lower quality) might be used to save space. By dynamically adjusting QP at the CTU level, the encoder can balance the quality and size of the video, ensuring that the output meets the desired bitrate while maintaining acceptable visual quality. CTU-level QP generation is used in adaptive encoding strategies as described herein, where encoding decisions and cost estimates are adjusted for various regions of the video frame. The selected QP for each CTU can be used for cost estimation and candidate selection as described herein, for example to optimize encoding efficiency and overall video quality. In some examples, the CTU level QP is provided by an application, such as by the application that provides the CTU input 110.

At module 135, the spatial variation calculation block, the CTU QP, and the DC adjustment ratio table are used to derive a table index to locate the corresponding DC adjustment ratio value in the DC adjustment ratio table.

At module 140, the selected DC adjustment ratio is used in SATD-based cost estimation to calculate adaptive SATD as follows:

$${SATD}_{adaptive} = {DC}_{ratio} * SATD ( DC ) + SATD ( AC )$$

The SATD includes two different parts of the signal after transformation: the DC component and the AC component. The DC (direct current) component can represent the average value or mean intensity of a block of pixels after transformation. In some examples, the DC component can represent the overall brightness or energy level of the block, thus indicating baseline intensity. Thus, the DC component can be used for reconstructing the general tone of an image region. The AC (alternating current) component of the SATD represents the variations around the mean of the block of pixels after transformation. Thus, the AC component can represent higher-frequency details after transformation. In some examples, the AC component can represent edges, textures, and fine details of the block. The AC component can indicate how pixel values change relative to the average. Thus, the AC component can be used for providing visual sharpness and detail.

As shown in the equation above, the adaptive SATD is determined based on the DC portion of the signal and the AC portion of the signal. The adaptive SATD indicates how different various blocks are in terms of overall intensity (DC) and variations (AC) that can represent various details. A weighting factor (DCᵣₐₜᵢₒ) is applied to the DC component of the adaptive SATD. In some examples, the DC component can have a different perceptual importance compared to the AC component, and the weighting factor accounts for the perceptual importance of the DC component compared to the AC component. For instance, if the DC difference is large, the overall brightness between blocks is highly variable, which can be visually significant, and the DC component may be more important. Conversely, if, for instance, the DC difference is small, the overall brightness between blocks is fairly consistent and the AC differences may be more important. By adjusting the DCᵣₐₜᵢₒ value, the encoder can adaptively emphasize or deemphasize the DC component based on a coding strategy, perceptual weighting, or other selected metric. Thus, the adaptive SATD cost metric combines both the DC and AC components, and weights the DC component according to its importance.

At module 150, the adaptive SATD is used to derive the cost of various candidates for a block, and to select a subset of candidates for the prediction and mode decision search. The candidates in the subset of candidates can differ in how the block is partitioned into sub-blocks, in prediction mode (intra-prediction vs inter-prediction, directional angles, etc.), in motion vectors used for inter-prediction, and in encoding mode (e.g., transform type, skip mode, etc.). The prediction and mode decision are used to decide the block partition, motion vector, and encoding mode. Thus, in some examples, the adaptive SATD represents a likelihood of accurate prediction. The candidates can be ranked based on the adaptive SATD value of each candidate, and, according to various examples, the subset of candidates are the candidates most likely to result in efficient block partitioning and accurate prediction.

### Example DC Adjustment Ratio Table Generation

FIG. 2 illustrates an example method 200 for generating a DC adjustment ratio table, according to various embodiments. According to various implementations, the DC adjustment ratio (or DC adjustment value) is determined based on a DC adjustment ratio table. According to various implementations, the DC adjustment ratio is highly correlated to the block level spatial variation and the encoding QP used by the CTU. The DC adjustment ratio table can be generated according to a number of training parameters as described with respect to FIG. 2. The DC adjustment ratio table can be generated offline. In some examples, a DC adjustment ratio table can be a universal table used for video codecs. In some examples, different DC adjustment tables can be generated for different codecs and/or for different applications.

In particular, to generate the DC adjustment ratio table, at 210, a set of CTUs is provided.

At 220, the set of CTUs are encoded with a first constant QP and different DC adjustment ratios. The DC adjustment ratios can range from 0% to 100%.

At 230, for each CTU in the set of CTUs, the DC adjustment ratio that achieves the best result is selected for the first constant QP. In some examples, the best result is the DC adjustment ratio that yields the lowest distortion for a selected bitrate. In some examples, the best result is the DC adjustment ratio that yields the lowest bitrate for a selected distortion.

At 240, the selected DC adjustment ratios are divided into N different zones.

At 250, the average spatial variation of the CTUs in each zone is determined. The average spatial variation of each zone Nis represented by S(N).

At 260, thresholds T are generated for each zone N based on the average spatial variation. In particular, N−1 thresholds are generated for use as zone boundaries. A zone threshold can be defined by the following equation:

$$T ( N - 1 ) = \frac{S ( N ) + S ( N - 1 )}{2}$$

Thus, if a CTU spatial variation value is larger than T(N−2), and less than or equal to T(N−1), the CTU spatial variation value belongs to zone N−1. Similarly, if the CTU spatial variation value is larger than T(N−1), the CTU spatial variation value belongs to zone N.

In some implementations, the set of CTU are encoded with one constant QP, and at 270, the DC adjustment ratio table is generated. In some implementations, more than one constant QP is used, and at 260, a next constant QP is generated, and 220-250 of the method 200 are repeated.

Thus, in one example, the set of CTUs are also encoded with a second constant QP and different DC adjustment ratios. The DC adjustment ratios can range from 0% to 100%. For each CTU in the set of CTUs, the DC adjustment ratio that achieves the best result is selected for the second constant QP. As described above, the selected DC adjustment ratios are divided into N different zones, and the average spatial variation of the CTUs in each zone is determined.

The above can be repeated with multiple constant QPs to generate a DC adjustment ratio table of any selected size. For each CTU, once then selected encoding QP and spatial variation are determined, a table index can be generated and the DC adjustment ratio for the selected QP and spatial variation can be recorded in the table. Subsequently, given a spatial variation and QP value, the corresponding DC adjustment ratio can be obtained from the table. In various examples, to generate the DC adjustment ratio table, the actions above can be repeated with M different QPs that vary from very low to very high.

In one example, M=6, and the various QP values are: QP={20, 24, 30, 36, 42, 46}. In this example, QP<20 belongs to class 1; 20<=QP<24 belongs to class 2; 24<=QP<30 belongs to class 3; 30<=QP<36 belongs to class 4; 36<=QP<42 belongs to class 5; 42<=QP<46 belongs to class 6 and 46<=QP belongs to class 7.

Using the method described above, a N×(M+1) DC adjustment ratio table is generated. In some examples, intra-prediction and inter-prediction encoding can use the same table. In some examples, one table is generated for intra-prediction encoding, and one table is generated for inter-prediction encoding. In some examples, generating separate tables for intra-prediction encoding and inter-prediction encoding can result in higher quality encoding output.

In various implementations, DC adjustment ratio table can include any number of spatial variation zones and any number of QP classes. In some examples, the 2D table can be a 1D table with N=1, such that only QP is adjusted while spatial variation remains constant. Similarly, in some examples, the table can be a 1D table with M=0 such that QP remains constant while spatial variation is adjusted.

### Example DC Adjustment Ratio Table

FIG. 3 illustrates an example of a DC adjustment ratio table 300, according to various embodiments. As shown in the table 300, the DC adjustment ratio parameters depend on the spatial variation and the QP.

In particular, T_{q} represents a QP-related threshold. When the QP is less than a first T_{q} threshold (T_{q1}), the first column of adjustment ratio parameters is used (D00, D10, D20), where the parameter used depends on the spatial variation. When the QP is greater than T_{q1} but less than a second T_{q} threshold (T_{q2}), the second column of adjustment ratio parameters is used (D01, D11, D21), where the parameter used depends on the spatial variation. When the QP is greater than T_{q2}, the third column of adjustment ratio parameters is used (D02, D12, D22), where the parameter used depends on the spatial variation.

Similarly, Tᵥ represents a spatial variation related threshold. When the spatial variation is less than a first Tᵥ threshold (Tᵥ₁), the first row of adjustment ratio parameters is used (D00, D01, D02), where the parameter used depends on the QP. When the spatial variation is greater than Tᵥ₁ but less than a second T_{q} threshold (Tᵥ₂), the second row of adjustment ratio parameters is used (D10, D11, D12), where the parameter used depends on the QP. When the spatial variation is greater than Tᵥ₂, the third column of adjustment ratio parameters is used (D20, D21, D22), where the parameter used depends on the QP.

In various examples, the threshold values T_{q1}, T_{q2}, Tᵥ₁, and Tᵥ₂ can be determined offline. In general, when the QP is large, most video details represented by the spatial quantization have already been lost, so the DC component is given more weight. When the QP value is large, the AC portion of the SATD signal is akin to noise in the signal. In contrast, when the QP is very small, the AC portion of the signal is more important as it represents details in the video, and the AC portion of the signal becomes dominant.

### Example Spatial Variance Determination

Spatial variance can be determined using various methods. Two examples of methods for determining spatial variation include a block sharpness estimation and a block variance estimation.

For the block sharpness estimation method, a CTU of an image frame is divided into blocks as described above, and a block sharpness estimation is determined for each block in the CTU. The maximum sharpness value of any of the blocks is used as the spatial variation value for the CTU. In one example, a CTU of an image frame is divided into 32×32 blocks. Thus, if the CTU size is 128×128, there are 16 32×32 blocks. If the CTU size is 64×64, there are 4 32×32 blocks. The block sharpness for each 32×32 block in the CTU can be determined using the following equation:

$${S}_{i} = \frac{1}{N} {\sum }_{x = 0}^{30} {\sum }_{y = 0}^{30} ( \vert ( P ( x , y ) - P ( x , y + 1 ) \vert / 2 + \vert ( P ( x , y ) - P ( x + 1 , y ) \vert / 2 )$$

where N is a constant weight factor, and P(x, y) denotes the pixel value for the pixel in the (x, y) position of the respective block. In one example, N=1024.

When the maximum sharpness value of any of the blocks is used as the spatial variation value for the CTU, the final spatial variation value of the CTU is:

$${S}_{final} = {argmax}_{i} \{ {S}_{i} \}$$

For the block variance estimation method of determining spatial variation, the CTU of an image frame is divided into blocks as described above, and a block variance estimation is determined for each block in the CTU. The maximum variance value of any of the blocks is used as the spatial variation value for the CTU. In one example, as above, a CTU of an image frame is divided into 32×32 blocks. The block variance for each 32×32 block in the CTU can be determined using the following equation:

$${S}_{i} = \frac{1}{N} {\sum }_{x = 0}^{31} {\sum }_{y = 0}^{31} {( P ( x , y ) - \overline{P} )}^{2}$$

where P(x, y) denotes the pixel value in (x, y) position of the respective block, P̅ denotes the average pixel value, and N=1024.

When the maximum variance value of any of the blocks is used as the spatial variation value for the CTU, the final spatial variation value of the CTU is:

$${S}_{final} = {argmax}_{i} \{ {S}_{i} \}$$

In some implementations, spatial variation can be determined using any selected method.

### Block Partitioning

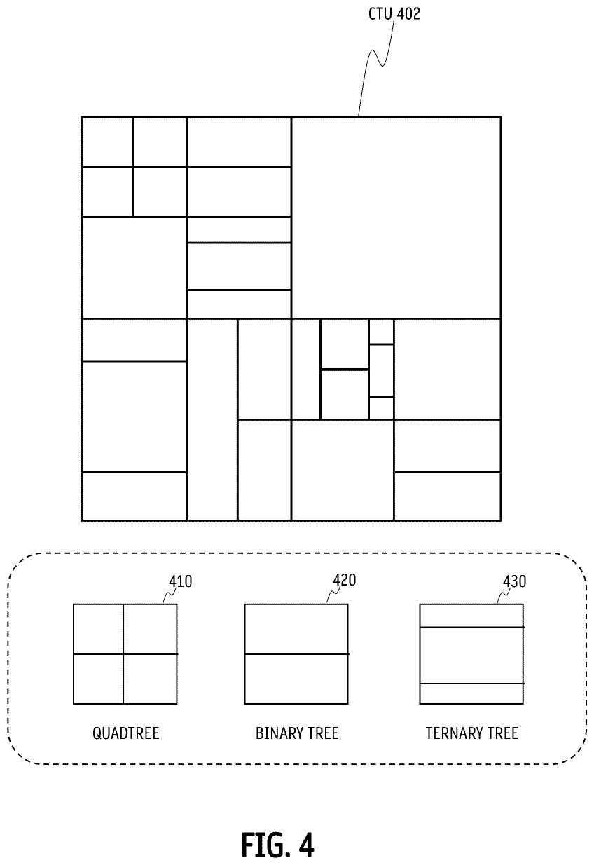

FIG. 4 illustrates partitioning, according to some embodiments of the disclosure. Video encoding standards can achieve coding gain by adding encoding modes, features, block partitions, finer motion vector resolutions, and so on. In VVC, a frame in a set of video frames may be partitioned into a plurality of non-overlapping CTUs. An exemplary CTU 402, and one exemplary way to partition CTU 402 is depicted. A CTU can have a specified size, such as 128×128 pixels, or 64×64 pixels. In some examples, a VVC CU can have a size ranging from 128×128 to 4×4. The CTU can be recursively split using different types of partitioning shapes. CTU 402 may be partitioned using a quadtree partitioning structure into 4 CUs. One or more of the CUs obtained through the quadtree partitioning structure can be recursively divided (e.g., up to three times) into smaller CUs using one of the multi-type structures, including, e.g., a quadtree, a binary tree, or ternary tree structure to support non-square partitions. Quadtree partitioning structure 410 can partition a CU into 4 CUs. Binary tree partitioning structure 420 can partition a CU into 2 CUs (e.g., divided horizontally or vertically). Ternary tree structure 430 can partition a CU into 3 CUs (e.g., divided horizontally or vertically). A smallest CU (e.g., referred to as a block or a partition) may have a size of 4×4 pixels. CUs may be larger than 4×4 pixels. It can be appreciated that CTU 402 may be partitioned into CUs through many different feasible partition combinations. CTU 402 may be partitioned in many different ways, resulting in many different partitioned results.

In various examples, the CTU 402 may be partitioned into blocks/partitions by partitioning, such as by intra-prediction and/or by inter-prediction.

### Intra-Prediction Modes

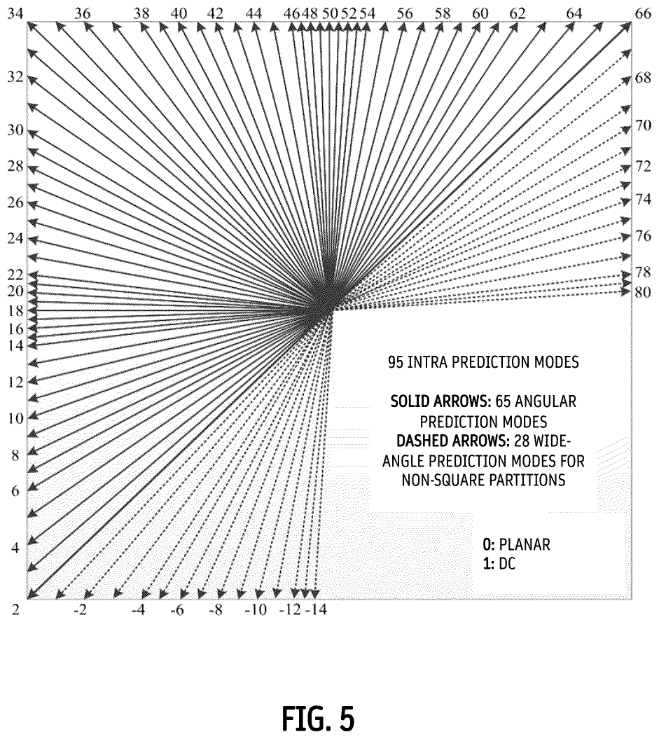

FIG. 5 illustrates intra-prediction modes, according to some embodiments of the disclosure. In VVC, a total of 95 intra-prediction modes or intra-frame predictors are supported.

Intra-prediction modes may include 65 angular prediction modes, depicted as solid arrows. The (even) number at the end of the arrow identifies the angular prediction mode illustrated by the arrow. An arrow between two even numbered arrows is identified by a corresponding odd number between the two even numbers. For example, an arrow between the arrow with number 38 and the arrow with number 40 is identified by the number 37. The 65 angular prediction modes may be identified by the numbers 2 through 66.

Intra-prediction modes may include 28 wide-angle prediction modes for non-square blocks/partitions (e.g., non-square CUs). The 28 wide-angle prediction modes may be identified by the numbers −1 through −14, and the numbers 67 through 80.

Intra-prediction modes may include a DC mode, which may be identified by the number 1.

Intra-prediction modes may include a planar mode, which may be identified by the number 0.

Intra-prediction coding tools, e.g., the 95 intra-prediction modes as illustrated in FIG. 5, are expected to be evaluated for all the feasible partition combinations or partitioned results as illustrated in FIG. 4 to determine an optimal intra-prediction decision for a CTU. The optimal intra-prediction decision would include how the CTU would be optimally partitioned and an optimal coding tool corresponding to each CU in the optimal partition result. Different combinations of feasible partition combinations and coding tools for each CU in each feasible partition may be evaluated. Specifically, RDO calculations may be computed for all the combinations of partition results and available intra-prediction coding tools for each CU in each partition result. There are too many combinations to evaluate in a practical manner. However, omitting certain combinations to decrease complexity is not a trivial task, because omitting certain combinations in a haphazard or arbitrary manner may result in non-optimal intra-prediction decision making and sub-optimal encoding results.

### Inter Coding

Inter coding (the process of encoding a frame using inter-prediction) includes motion estimation and compensation (prediction), encoding motion vectors, residuals, and partitioning information, and applying transforms, quantization, and entropy coding to the residuals. Inter coding can use the temporal redundancy between video frames to predict the content of the current frame using information from previously encoded frames. In some examples, the prediction is achieved by identifying blocks in the previously encoded frames that match blocks in the current frame and then only encoding differences.

A motion vector can describe the displacement of a block from its position in a current frame to its best-matching position in a previous frame. Efficient prediction and compression rely on the accuracy of the motion vector. Earlier standards like H.264/AVC supported motion vector accuracy down to ¼ pixel. More recent standards, such as VVC, have increased this precision to ⅛ pixel resolution. Additionally, more recent coding standards, such as VVC have expanded the number of prediction modes available for inter coding, including a wide range of block partitioning options, and prediction modes.

As discussed above, the systems and method provided herein reduce the complexity of identifying an optimal partitioning and coding tool for a CTU.

### Example System for Video Encoding and Decoding

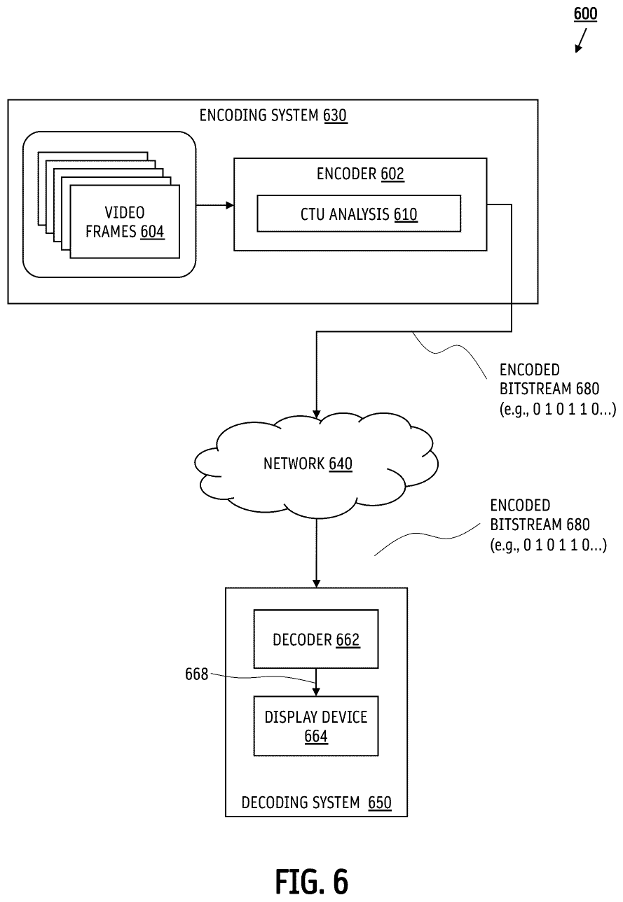

FIG. 6 illustrates an example system 600 for encoding and decoding video frames 604, including an encoding system 630 and a decoding system 650, according to some embodiments of the disclosure. The encoding system 630 includes a CTU analysis block 610 for performing adaptive prediction cost estimation, as described herein.

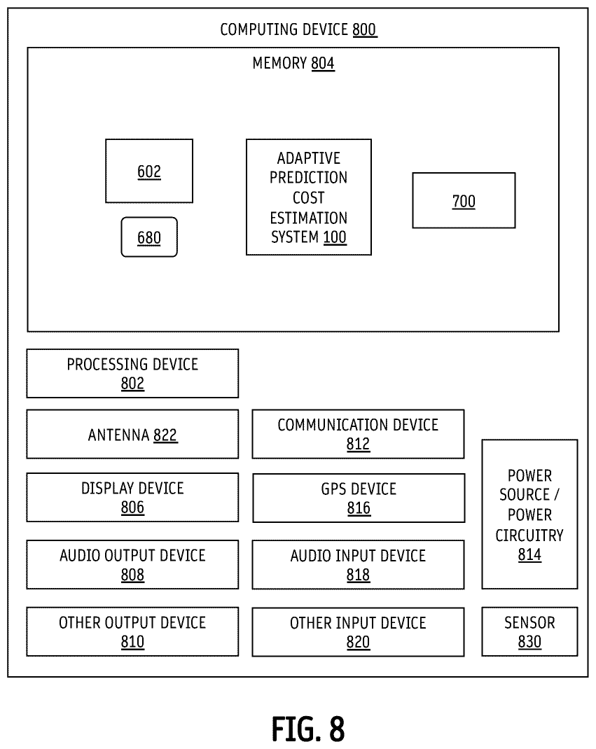

The encoding system 630 may be implemented on computing device 800 of FIG. 8. The encoding system 630 can be implemented in the cloud or in a data center. The encoding system 630 can be implemented on a device that is used to capture the video. The encoding system 630 can be implemented on a standalone computing system. The encoding system 630 may perform the process of encoding in video compression. The encoding system 630 may receive a video (e.g., uncompressed video, original video, raw video, etc.) comprising a sequence of video frames 604. The video frames 604 may include image frames or images that make up the video. A video may have a frame rate or number of frames per second (FPS), that defines the number of frames per second of video. The higher the FPS, the more realistic and fluid the video looks. Typically, FPS is greater than 24 frames per second for a natural, realistic viewing experience to a human viewer. Examples of video may include a television episode, a movie, a short film, a short video (e.g., less than 15 seconds long), a video capturing gaming experience, computer screen content, video conferencing content, live event broadcast content, sports content, a surveillance video, a video shot using a mobile computing device (e.g., a smartphone), etc. In some cases, video may include a mix or combination of different types of video.

The encoding system 630 may include an encoder 602 that receives video frames 604 and encodes video frames 604 into encoded bitstream 680. The encoder 602 can include a CTU analysis block 610 that implements adaptive prediction cost estimation to reduce the number of candidates for the later decision stages and, for example, for a final RDO stage. In some examples, the candidates can include block partitioning candidates, intra-prediction candidates, and/or inter-prediction candidates. In some examples, the CTU analysis block 610 can evaluate the possible prediction/mode candidates for the encoder 602, and select a subset of candidates for an RDO stage evaluation.

In some implementations, the encoder 602 performs rate distortion optimization (RDO) on the subset of candidates generated by the CTU analysis block 610, and selects a candidate that provides an optimal trade-off between distortion and bitrate within the QP and coding selections. The selected candidate determines how the block is partitioned, inter-vs. intra-prediction mode, and motion information including reference frame(s), motion vectors, and merge options. The encoder 602 uses the configuration provided by the selected candidate to encode a CTU block. Using this process, the encoder 602 encodes each frame of the video frames 604 and generate an encoded bitstream 680.

The encoded bitstream 680 may be compressed, meaning that the encoded bitstream 680 may be smaller in size than video frames 604. The encoded bitstream 680 may include a series of bits, e.g., having 0's and 1's. The encoded bitstream 680 may have header information, payload information, and footer information, which may be encoded as bits in the bitstream. Header information may provide information about one or more of: the format of the encoded bitstream 680, the encoding process implemented in the encoder 602, the parameters of the encoder 602, and metadata of the encoded bitstream 680. For example, header information may include one or more of: resolution information, frame rate, aspect ratio, color space, etc. Payload information may include data representing content of video frames 604, such as samples frames, symbols, syntax elements, etc. For example, payload information may include bits that encode one or more of motion predictors, transform coefficients, prediction modes, and quantization levels of video frames 604. Footer information may indicate an end of the encoded bitstream 680. Footer information may include other information including one or more of: checksums, error correction codes, and signatures. Format of the encoded bitstream 680 may vary depending on the specification of the encoding and decoding process, i.e., the codec.

The encoded bitstream 680 may include packets, where encoded video data and signaling information may be packetized. One exemplary format is the Open Bitstream Unit (OBU), which is used in AV1 encoded bitstreams. An OBU may include a header and a payload. The header can include information about the OBU, such as information that indicates the type of OBU. Examples of OBU types may include sequence header OBU, frame header OBU, metadata OBU, temporal delimiter OBU, and tile group OBU. Payloads in OBUs may carry quantized transform coefficients and syntax elements that may be used in the decoder to properly decode the encoded video data to regenerate video frames.

The encoded bitstream 680 may be transmitted to one or more decoding systems 650 via network 640. The network 640 may be the Internet. The network 640 may include one or more of: cellular data networks, wireless data networks, wired data networks, cable Internet networks, fiber optic networks, satellite Internet networks, etc.

The decoding systems 250 may be implemented on the computing device 800 of FIG. 8. Examples of systems 250 may include personal computers, mobile computing devices, gaming devices, augmented reality devices, mixed reality devices, virtual reality devices, televisions, etc. Each one of decoding systems 250 may perform the process of decoding in video compression. Each one of decoding systems 250 may include a decoder (e.g., decoder 662), and one or more display devices (e.g., display device 264).

For example, a decoding system 650 may include a decoder 662 and a display device 664. The decoder 662 may implement a decoding process of video compression. The decoder 662 may receive the encoded bitstream 680 and produce decoded video 668. The decoded video 668 may include a series of video frames, which may be a version or reconstructed version of video frames 604 encoded by the encoding system 630. The display device 664 may output the decoded video 668 for display to one or more human viewers or users of the decoding system 650.

### Example Method for Adaptive Cost Estimation

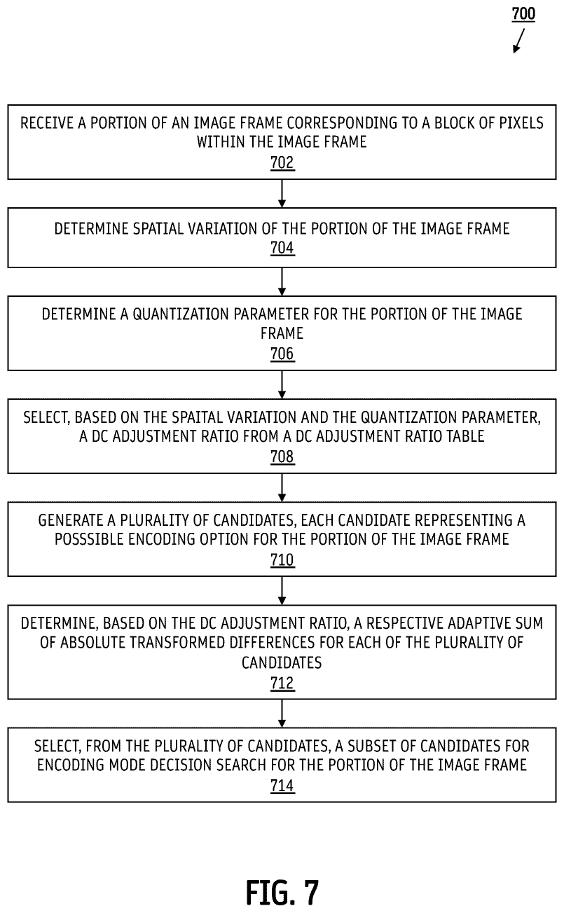

FIG. 7 illustrates an adaptive cost estimation method 700, according to some embodiments of the disclosure. The adaptive cost estimation method 700 may be performed by one or more components illustrated in the adaptive cost estimation system 100 of FIG. 1. The method 700 may be encoded as instructions on memory 804, which may be executed by processing device 802 of computing device 800 of FIG. 8.

At 702, a portion of an image frame is received, wherein the portion of the image frame corresponds to a block of pixels within the image frame. In some examples, the portion of the image frame is received at an encoder. The portion of the image frame can be, for example, a Coding Tree Unit (CTU). The portion of the image frame can be the unit for prediction and mode decision in a codec, such as HEVC, VVC, AV1, and AV2.

At 704, spatial variation of the portion of the image frame is determined. In some examples, an encoder calculates the spatial variation of the portion of the image frame, which represents the degree of pixel intensity change within the portion of the image frame. Low spatial variation indicates smooth regions (e.g., monotonic backgrounds), while high variation indicates detailed or textured regions (e.g., text or sharp edges). In some examples, the spatial variation metric can help assess complexity and visual importance.

At 706, a quantization parameter (QP) for the portion of the image frame is determined. A QP value is determined for the portion of the image frame based on bitrate control and encoding settings. QP can influence compression strength. In particular, lower QP preserves quality for complex regions, while higher QP applies stronger compression for simpler regions. In some examples, adjustment of QP can help provide bitrate targets while maintaining visual fidelity.

At 708, a DC adjustment ratio is selected from a DC adjustment ratio table. The DC adjustment ratio is selected based on the spatial variation and the QP. In some examples, using the spatial variation and QP, the encoder selects a DC adjustment ratio from a precomputed DC adjustment ratio table. The DC adjustment ratio is designed to weight the DC component of the cost metric to reflect perceptual importance and a selected coding strategy.

At 710, a plurality of candidates is generated. Each candidate represents a possible encoding option for the portion of the image frame. In some examples, the encoder generates multiple candidates for encoding the portion of the image frame. Each candidate represents a possible encoding option, which, in various examples, may differ in one or more of: partitioning (split patterns), prediction mode (intra vs. inter, directional angles), motion vectors and reference frames, transform and skip modes.

At 712, an adaptive SATD is determined for each candidate. The adaptive SATD is determined based on the DC adjustment ratio. In some examples, for each candidate, the encoder computes an adaptive Sum of Absolute Transformed Differences (SATD) using a formula that weights the DC component of the SATD using the DC adjustment ratio, as described above with respect to FIG. 1. In various examples, the DC adjustment ratio adjusts the weight of the DC component based on spatial variation and QP.

At 714, a subset of candidates is selected for encoding mode decision search for the portion of the image frame. In various examples, based on the adaptive SATD values, the encoder ranks the candidates and selects a subset most likely to yield efficient prediction and optimal rate-distortion performance. The subset of candidates proceeds to full RDO for final mode decision, reducing complexity while maintaining quality.

According to various implementations, the method 700, can be implemented as is part of the system 100 for adaptive prediction cost estimation. The method 700 improves encoding efficiency by reducing the number of candidates evaluated in full RDO, which is computationally expensive. By adaptively weighting DC and AC components, the system can reduce complexity with minimal quality loss. In some examples, the system can maintain complexity and provide improved quality.

### Exemplary Computing Device

FIG. 8 is a block diagram of an apparatus or a system, e.g., an exemplary computing device 800, according to some embodiments of the disclosure. One or more computing devices 800 may be used to implement the functionalities described with the FIGS. and herein. A number of components are illustrated in the FIGS. can be included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, and the computing device 800 may include interface circuitry for coupling to the one or more components. For example, the computing device 800 may not include a display device 806, and may include display device interface circuitry (e.g., a connector and driver circuitry) to which a display device 806 may be coupled. In another set of examples, the computing device 800 may not include an audio input device 818 or an audio output device 808 and may include audio input or output device interface circuitry (e.g., connectors and supporting circuitry) to which an audio input device 818 or audio output device 808 may be coupled.

The computing device 800 may include a processing device 802 (e.g., one or more processing devices, one or more of the same types of processing device, one or more of different types of processing device). The processing device 802 may include processing circuitry or electronic circuitry that process electronic data from data storage elements (e.g., registers, memory, resistors, capacitors, quantum bit cells) to transform that electronic data into other electronic data that may be stored in registers and/or memory. Examples of processing device 802 may include a CPU, a GPU, a quantum processor, a machine learning processor, an artificial intelligence processor, a neural-network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 804 includes one or more non-transitory computer-readable storage media. In some embodiments, memory 804 may include memory that shares a die with the processing device 802.

In some embodiments, memory 804 includes one or more non-transitory computer-readable media storing instructions executable to perform operations described herein, such as operations illustrated in FIGS. 1-7, and adaptive cost estimation process 700. In some embodiments, the memory 804 includes one or more non-transitory computer-readable media storing instructions executable to perform one or more operations of an encoder, such as the encoder 602 of FIG. 6. In some embodiments, memory 804 includes one or more non-transitory computer-readable media storing instructions executable to perform one or more operations of adaptive cost estimation, as provided herein. The instructions stored in memory 804 may be executed by processing device 802.

In some embodiments, memory 804 may store data, e.g., data structures, binary data, bits, metadata, files, blobs, etc., as described with the FIGS. and herein. Memory 804 may include one or more non-transitory computer-readable media storing one or more of: input frames to the encoder (e.g., video frames 104), intermediate data structures computed by the encoder, bitstream generated by the encoder (encoded bitstream 680), bitstream received by a decoder (encoded bitstream 680), intermediate data structures computed by the decoder, and reconstructed frames generated by the decoder. Memory 804 may include one or more non-transitory computer-readable media storing one or more of: data received and/or data generated by the systems and methods of FIGS. 1, 2, 6, and 7. Memory 804 may include one or more non-transitory computer-readable media storing one or more of: data received and/or data generated by process 700 of FIG. 7. Memory 804 may include one or more non-transitory computer-readable media storing one or more of: data received and/or data generated by process 700 of FIG. 7.

In some embodiments, the computing device 800 may include a communication device 812 (e.g., one or more communication devices). For example, the communication device 812 may be configured for managing wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 4G, 4G, 5G, and beyond. The communication device 812 may operate in accordance with other wireless protocols in other embodiments. The computing device 800 may include an antenna 822 to facilitate wireless communications and/or to receive other wireless communications (such as radio frequency transmissions). Computing device 800 may include receiver circuits and/or transmitter circuits. In some embodiments, the communication device 812 may manage wired communications, such as electrical, optical, or any other suitable communication protocols (e.g., the Ethernet). As noted above, the communication device 812 may include multiple communication chips. For instance, a first communication device 812 may be dedicated to shorter-range wireless communications such as Wi-Fi or Bluetooth, and a second communication device 812 may be dedicated to longer-range wireless communications such as global positioning system (GPS), EDGE, GPRS, CDMA, WiMAX, LTE, EV-DO, or others. In some embodiments, a first communication device 812 may be dedicated to wireless communications, and a second communication device 812 may be dedicated to wired communications.

The computing device 800 may include power source/power circuitry 814. The power source/power circuitry 814 may include one or more energy storage devices (e.g., batteries or capacitors) and/or circuitry for coupling components of the computing device 800 to an energy source separate from the computing device 800 (e.g., DC power, AC power, etc.).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include a sensor 830 (or one or more sensors). The computing device 800 may include corresponding interface circuitry, as discussed above). Sensor 830 may sense physical phenomenon and translate the physical phenomenon into electrical signals that can be processed by, e.g., processing device 802. Examples of sensor 830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 800 may be any other electronic device that processes data.

### Select Examples

Example 1 provides a system, including one or more processors; and one or more non-transitory computer-readable media storing instructions that, when executed by the one or more processors, cause the one or more processors to: receive, at an encoder, a portion of an image frame corresponding to a block of pixels within the image frame; determine spatial variation of the portion of the image frame; determine a quantization parameter for the portion of the image frame; select, based on the spatial variation and the quantization parameter, a DC adjustment ratio from a DC adjustment ratio table; generate a plurality of candidates, each candidate representing a possible encoding option for the portion of the image frame; determine, based on the DC adjustment ratio, a respective adaptive sum of absolute transformed differences for each of the plurality of candidates; select, from the plurality of candidates, a subset of candidates for encoding mode decision search for the portion of the image frame.

Example 2 provides the system of example 1, where the portion of the frame is a coding tree unit.

Example 3 provides the system of example 1 or 2, where determining the respective adaptive sum of absolute transformed differences for each of the plurality of candidates includes determining a DC component of the respective adaptive sum of absolute transformed differences, determining an AC component of the respective adaptive sum of absolute transformed differences, and weighting the DC component by the DC adjustment ratio.

Example 4 provides the system of example 3, where the one or more non-transitory computer-readable media further store instructions that cause the one or more processors to: rank each of the plurality of candidates based on the respective adaptive sum of absolute transformed differences for each of the plurality of candidates, and where selecting the subset of candidates includes selecting subset of candidates based on the rank.

Example 5 provides the system of any one of examples 1-4, where determining the spatial variation of the portion of the image frame includes dividing the portion of the image frame into a plurality of segments, determining a respective block sharpness value for each of the plurality of segments, and identifying a maximum block sharpness of the respective block sharpness values, where the spatial variation is the maximum block sharpness.

Example 6 provides the system of any one of examples 1-5, where determining the spatial variation of the portion of the image frame includes dividing the portion of the image frame into a plurality of segments, determining a respective block variance value for each of the plurality of segments, and identifying a maximum block variance of the respective block variance values, where the spatial variation is the maximum block variance.

Example 7 provides the system of any one of examples 1-6, where determining the quantization parameter for the coding unit includes generating the quantization parameter based on bitrate control.

Example 8 provides the system of any one of examples 1-7, where the one or more non-transitory computer-readable media further store instructions that cause the one or more processors to: generate the DC adjustment ratio table using offline training, the offline training including analyzing a plurality of video sequences to determine selected DC adjustment ratios for different spatial variations and for different quantization parameter conditions.

Example 9 provides the system of example 8, where generating the DC adjustment ratio table further includes encoding each of a set coding tree units using a selected constant quantization parameter, selecting, for each of the set of coding tree units, a selected adjustment ratio, dividing the DC adjustment ratios into N zones, determining an average spatial variation of the coding tree units in each of the N zones, and determining threshold values for each of the N zones.

Example 10 provides the system of example 9, where generating the DC adjustment ratio table further includes, for each selected constant quantization parameter, and for the average spatial variation of the coding tree units in each of the N zones, adding the selected adjustment ratio for each of the set of coding tree units to the DC adjustment ratio table.

Example 11 provides one or more non-transitory computer-readable media storing instructions that, when executed by one or more processors, cause the one or more processors to: receive, at an encoder, a portion of an image frame corresponding to a block of pixels within the image frame; determine spatial variation of the portion of the image frame; determine a quantization parameter for the portion of the image frame; select, based on the spatial variation and the quantization parameter, a DC adjustment ratio from a DC adjustment ratio table; generate a plurality of candidates, each candidate representing a possible encoding option for the portion of the image frame; determine, based on the DC adjustment ratio, a respective adaptive sum of absolute transformed differences for each of the plurality of candidates; select, from the plurality of candidates, a subset of candidates for encoding mode decision search for the portion of the image frame.

Example 12 provides the one or more non-transitory computer-readable media of example 11, where determining the respective adaptive sum of absolute transformed differences for each of the plurality of candidates includes determining a DC component of the respective adaptive sum of absolute transformed differences, determining an AC component of the respective adaptive sum of absolute transformed differences, and weighting the DC component by the DC adjustment ratio.

Example 13 provides the one or more non-transitory computer-readable media of example 12, where the instructions further cause the one or more processors to: rank each of the plurality of candidates based on the respective adaptive sum of absolute transformed differences for each of the plurality of candidates, and where selecting the subset of candidates includes selecting subset of candidates based on the rank.

Example 14 provides the one or more non-transitory computer-readable media of any one of examples 11-13, where determining the spatial variation of the portion of the image frame includes dividing the portion of the image frame into a plurality of segments, determining a respective block sharpness value for each of the plurality of segments, and identifying a maximum block sharpness of the respective block sharpness values, where the spatial variation is the maximum block sharpness.

Example 15 provides the one or more non-transitory computer-readable media of any one of examples 11-14, where determining the spatial variation of the portion of the image frame includes dividing the portion of the image frame into a plurality of segments, determining a respective block variance value for each of the plurality of segments, and identifying a maximum block variance of the respective block variance values, where the spatial variation is the maximum block variance.

Example 16 provides the one or more non-transitory computer-readable media of any one of examples 11-15, where determining the quantization parameter for the coding unit includes generating the quantization parameter based on bitrate control.

Example 17 provides the one or more non-transitory computer-readable media of any one of examples 11-16, where the instructions further cause the one or more processors to: generate the DC adjustment ratio table using offline training, the offline training including analyzing a plurality of video sequences to determine selected DC adjustment ratios for different spatial variations and for different quantization parameter conditions.

Example 18 provides the one or more non-transitory computer-readable media of example 17, where generating the DC adjustment ratio table further includes encoding each of a set coding tree units using a selected constant quantization parameter, selecting, for each of the set of coding tree units, a selected adjustment ratio, dividing the DC adjustment ratios into N zones, determining an average spatial variation of the coding tree units in each of the N zones, and determining threshold values for each of the N zones.

Example 19 provides the one or more non-transitory computer-readable media of example 18, where generating the DC adjustment ratio table further includes, for each selected constant quantization parameter, and for the average spatial variation of the coding tree units in each of the N zones, adding the selected adjustment ratio for each of the set of coding tree units to the DC adjustment ratio table.

Example 20 provides a computer-implemented method, including receiving, at an encoder, a portion of an image frame corresponding to a block of pixels within the image frame; determining spatial variation of the portion of the image frame; determining a quantization parameter for the portion of the image frame; selecting, based on the spatial variation and the quantization parameter, a DC adjustment ratio from a DC adjustment ratio table; generating a plurality of candidates, each candidate representing a possible encoding option for the portion of the image frame; determining, based on the DC adjustment ratio, a respective adaptive sum of absolute transformed differences for each of the plurality of candidates; and selecting, from the plurality of candidates, a subset of candidates for encoding mode decision search for the portion of the image frame.

Example 21 provides the computer-implemented method of example 20, where determining the respective adaptive sum of absolute transformed differences for each of the plurality of candidates includes determining a DC component of the respective adaptive sum of absolute transformed differences, determining an AC component of the respective adaptive sum of absolute transformed differences, and weighting the DC component by the DC adjustment ratio.

Example 22 provides the computer-implemented method of example 21, further including ranking each of the plurality of candidates based on the respective adaptive sum of absolute transformed differences for each of the plurality of candidates, where selecting the subset of candidates includes selecting subset of candidates based on the ranking.

Example 23 provides the computer-implemented method of any one of examples 20-22, where determining the spatial variation of the portion of the image frame includes dividing the portion of the image frame into a plurality of segments, determining a respective block sharpness value for each of the plurality of segments, and identifying a maximum block sharpness of the respective block sharpness values, where the spatial variation is the maximum block sharpness.

Example 24 provides the method of any one of examples 20-23, where determining the spatial variation of the portion of the image frame includes dividing the portion of the image frame into a plurality of segments, determining a respective block variance value for each of the plurality of segments, and identifying a maximum block variance of the respective block variance values, where the spatial variation is the maximum block variance.

Example 25 provides the computer-implemented method of any one of examples 20-24, where determining the quantization parameter for the coding unit includes generating the quantization parameter based on bitrate control.

Example 26 provides the computer-implemented method of any one of examples 20-25, further including generating the DC adjustment ratio table using offline training, the offline training including analyzing a plurality of video sequences to determine selected DC adjustment ratios for different spatial variations and for different quantization parameter conditions.

Example 27 provides the computer-implemented method of example 24, where generating the DC adjustment ratio table further includes encoding each of a set coding tree units using a selected constant quantization parameter, selecting, for each of the set of coding tree units, a selected adjustment ratio, dividing the DC adjustment ratios into N zones, determining an average spatial variation of the coding tree units in each of the N zones, and determining threshold values for each of the N zones.

Example 28 provides the computer-implemented method of example 27, where generating the DC adjustment ratio table further includes, for each selected constant quantization parameter, and for the average spatial variation of the coding tree units in each of the N zones, adding the selected adjustment ratio for each of the set of coding tree units to the DC adjustment ratio table.

Example 29 provides the method of example 27, where selecting the selected adjustment ratio includes calculating, includes, for each of the set of coding tree units: determining a plurality of potential adjustment ratios at a selected bitrate, and identifying a first potential adjustment ratio of the plurality of potential adjustment ratios that yields a lowest distortion for the selected bitrate.

Example 30 provides the system of example 27, where selecting the selected adjustment ratio includes calculating, includes, for each of the set of coding tree units: determining a plurality of potential adjustment ratios at a selected distortion, and identifying a first potential adjustment ratio of the plurality of potential adjustment ratios that yields a lowest bitrate for the selected distortion.

Example 31 provides the system of example 9, where selecting the selected adjustment ratio includes calculating, includes, for each of the set of coding tree units: determining a plurality of potential adjustment ratios at a selected bitrate, and identifying a first potential adjustment ratio of the plurality of potential adjustment ratios that yields a lowest distortion for the selected bitrate.

Example 32 provides the system of example 9, where selecting the selected adjustment ratio includes calculating, includes, for each of the set of coding tree units: determining a plurality of potential adjustment ratios at a selected distortion, and identifying a first potential adjustment ratio of the plurality of potential adjustment ratios that yields a lowest bitrate for the selected distortion.

Example A provides an apparatus comprising means to carry out or means for carrying out any one of the methods provided in examples 20-30 and methods/processes described herein.

Example B provides one or more non-transitory computer-readable media storing instructions that, when executed by one or more processors, cause the one or more processors to perform any one of the methods provided in examples 20-30 and methods/processes described herein.

Example C provides an apparatus, comprising: one or more processors to execute instructions, and one or more non-transitory computer-readable media storing the instructions that, when executed by one or more processors, cause the one or more processors to perform any one of the methods provided in examples 20-30 and methods/processes described herein.

Example D provides an encoder to generate an encoded bitstream using operations described herein.

Example E provides an encoder to perform any one of the methods provided in examples 2-28 and methods/processes described herein.

### Variations and Other Notes

Although the operations of the example method shown in and described with reference to FIGS. 2 and 7 are illustrated as occurring once each and in a particular order, it will be recognized that some operations may be performed in any suitable order and repeated as desired. Furthermore, the operations illustrated in FIGS. 2 and 7 or other FIGS. may be combined or may include more or fewer details than described. The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second thresholds are set in a manner so that both statements result in the same logical outcome for any value of A. For the purposes of the present disclosure, “B is greater than a first threshold” is equivalent to “B is greater than or equal to a second threshold” provided that the first threshold and the second thresholds are set in a manner so that both statements result in the same logical outcome for any value of B.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. A system, comprising:
one or more processors; and
one or more non-transitory computer-readable media storing instructions that, when executed by the one or more processors, cause the one or more processors to:
receive, at an encoder, a portion of an image frame corresponding to a block of pixels within the image frame;
determine spatial variation of the portion of the image frame;
determine a quantization parameter for the portion of the image frame;
select, based on the spatial variation and the quantization parameter, a DC adjustment ratio from a DC adjustment ratio table;
generate a plurality of candidates, each candidate representing a possible encoding option for the portion of the image frame;
determine, based on the DC adjustment ratio, a respective adaptive sum of absolute transformed differences for each of the plurality of candidates; and
select, from the plurality of candidates, a subset of candidates for encoding mode decision search for the portion of the image frame.

2. The system of claim 1, wherein the portion of the image frame is a coding tree unit.

3. The system of claim 1, wherein determining the respective adaptive sum of absolute transformed differences for each of the plurality of candidates includes:
determining a DC component of the respective adaptive sum of absolute transformed differences,
determining an AC component of the respective adaptive sum of absolute transformed differences, and
weighting the DC component by the DC adjustment ratio.

4. The system of claim 3, wherein the one or more non-transitory computer-readable media further store instructions that cause the one or more processors to: rank each of the plurality of candidates based on the respective adaptive sum of absolute transformed differences for each of the plurality of candidates, and wherein selecting the subset of candidates includes selecting subset of candidates based on the rank.

5. The system of claim 1, wherein determining the spatial variation of the portion of the image frame includes:
dividing the portion of the image frame into a plurality of segments,
determining a respective block sharpness value for each of the plurality of segments, and
identifying a maximum block sharpness of the respective block sharpness values, wherein the spatial variation is the maximum block sharpness.

6. The system of claim 1, wherein determining the spatial variation of the portion of the image frame includes:
dividing the portion of the image frame into a plurality of segments,
determining a respective block variance value for each of the plurality of segments, and
identifying a maximum block variance of the respective block variance values, wherein the spatial variation is the maximum block variance.

7. The system of claim 1, wherein determining the quantization parameter for the portion of the image frame includes generating the quantization parameter based on bitrate control.

8. The system of claim 1, wherein the one or more non-transitory computer-readable media further store instructions that cause the one or more processors to: generate the DC adjustment ratio table using offline training, the offline training comprising analyzing a plurality of video sequences to determine selected DC adjustment ratios for different spatial variations and for different quantization parameter conditions.

9. The system of claim 8, wherein generating the DC adjustment ratio table further comprises:
encoding each of a set coding tree units using a selected constant quantization parameter,
selecting, for each of the set of coding tree units, a selected adjustment ratio,
dividing the DC adjustment ratios into N zones,
determining an average spatial variation of the coding tree units in each of the N zones, and
determining threshold values for each of the N zones.

10. The system of claim 9, wherein generating the DC adjustment ratio table further comprises, for each selected constant quantization parameter, and for the average spatial variation of the coding tree units in each of the N zones, adding the selected adjustment ratio for each of the set of coding tree units to the DC adjustment ratio table.

11. One or more non-transitory computer-readable media storing instructions that, when executed by one or more processors, cause the one or more processors to:
receive, at an encoder, a portion of an image frame corresponding to a block of pixels within the image frame;
determine spatial variation of the portion of the image frame;
determine a quantization parameter for the portion of the image frame;
select, based on the spatial variation and the quantization parameter, a DC adjustment ratio from a DC adjustment ratio table;
generate a plurality of candidates, each candidate representing a possible encoding option for the portion of the image frame;
determine, based on the DC adjustment ratio, a respective adaptive sum of absolute transformed differences for each of the plurality of candidates; and
select, from the plurality of candidates, a subset of candidates for encoding mode decision search for the portion of the image frame.

12. The one or more non-transitory computer-readable media of claim 11, wherein determining the respective adaptive sum of absolute transformed differences for each of the plurality of candidates includes:
determining a DC component of the respective adaptive sum of absolute transformed differences,
determining an AC component of the respective adaptive sum of absolute transformed differences, and
weighting the DC component by the DC adjustment ratio.

13. The one or more non-transitory computer-readable media of claim 12, wherein the instructions further cause the one or more processors to: rank each of the plurality of candidates based on the respective adaptive sum of absolute transformed differences for each of the plurality of candidates, and wherein selecting the subset of candidates includes selecting subset of candidates based on the rank.

14. The one or more non-transitory computer-readable media of claim 11, wherein determining the spatial variation of the portion of the image frame includes:
dividing the portion of the image frame into a plurality of segments,
determining a respective block sharpness value for each of the plurality of segments, and
identifying a maximum block sharpness of the respective block sharpness values, wherein the spatial variation is the maximum block sharpness.

15. The one or more non-transitory computer-readable media of claim 11, wherein determining the spatial variation of the portion of the image frame includes:
dividing the portion of the image frame into a plurality of segments,
determining a respective block variance value for each of the plurality of segments, and
identifying a maximum block variance of the respective block variance values, wherein the spatial variation is the maximum block variance.

16. The one or more non-transitory computer-readable media of claim 11, wherein determining the quantization parameter for the portion of the image frame includes generating the quantization parameter based on bitrate control.

17. The one or more non-transitory computer-readable media of claim 11, wherein the instructions further cause the one or more processors to: generate the DC adjustment ratio table using offline training, the offline training comprising analyzing a plurality of video sequences to determine selected DC adjustment ratios for different spatial variations and for different quantization parameter conditions.

18. The one or more non-transitory computer-readable media of claim 17, wherein generating the DC adjustment ratio table further comprises:
encoding each of a set coding tree units using a selected constant quantization parameter,
selecting, for each of the set of coding tree units, a selected adjustment ratio,
dividing the DC adjustment ratios into N zones,
determining an average spatial variation of the coding tree units in each of the N zones, and
determining threshold values for each of the N zones.

19. The one or more non-transitory computer-readable media of claim 18, wherein generating the DC adjustment ratio table further comprises, for each selected constant quantization parameter, and for the average spatial variation of the coding tree units in each of the N zones, adding the selected adjustment ratio for each of the set of coding tree units to the DC adjustment ratio table.

20. A computer-implemented method, comprising:
receiving, at an encoder, a portion of an image frame corresponding to a block of pixels within the image frame;
determining spatial variation of the portion of the image frame;
determining a quantization parameter for the portion of the image frame;
selecting, based on the spatial variation and the quantization parameter, a DC adjustment ratio from a DC adjustment ratio table;
generating a plurality of candidates, each candidate representing a possible encoding option for the portion of the image frame;
determining, based on the DC adjustment ratio, a respective adaptive sum of absolute transformed differences for each of the plurality of candidates; and
selecting, from the plurality of candidates, a subset of candidates for encoding mode decision search for the portion of the image frame.
